(19) United States
(12) Patent Application Publication
(10) Pub. No.: US 2012/0239399 A1
(43) Pub. Date: Sep. 20, 2012

(54) VOICE RECOGNITION DEVICE

(76) Inventors: Michihiro Yamazaki, Tokyo (JP); Yuzo Maruta, Tokyo (JP)

(21) Appl. No.: 13/514,251

(22) PCT Filed: Mar. 30, 2010
(86) PCT No.: PCT/JP2010/002323

§ 371 Date: Jun. 6, 2012

(51) Int. Cl. G10L 15/06; G10L 17/00

(52) U.S. Cl. 704/243; 704/E17.001; 704/E15.007

(57) ABSTRACT

Disclosed is a voice recognition device which creates a recognition dictionary (statically-created dictionary) in advance for a vocabulary having words to be recognized whose number is equal to or larger than a threshold, and creates a recognition dictionary (dynamically-created dictionary) for a vocabulary having words to be recognized whose number is smaller than the threshold in an interactive situation.

### FIELD OF THE INVENTION

The present invention relates to a voice recognition device which performs voice recognition on an inputted voice.

### BACKGROUND OF THE INVENTION

A conventional voice recognition device, which performs voice recognition such as large-size vocabulary voice recognition while narrowing a vocabulary including words which are objects to be recognized in an interactive manner, typically creates a voice recognition dictionary (referred to as a recognition dictionary from here on) corresponding to the contents of interactions in advance. Therefore, in a case of creating recognition dictionaries corresponding to various interaction contents, respectively, a large-volume storage unit for storing the recognition dictionaries created in advance is needed.

Further, in addition to the above-mentioned creation of recognition dictionaries in advance, an on-line collection of words to be recognized according to the progressing state of interactive communications with the user to create a recognition dictionary is also performed. In this case, the creation of a recognition dictionary in every situation where the conventional voice recognition device performs voice recognition lengthens the time (compiling time etc.) required to create the recognition dictionary as the number of words which are collected on line increases. This time required to create the dictionary is the waiting time which is imposed on the user during the interactive communications.

Patent reference 1 discloses a voice information searching device which can dynamically change a vocabulary for voice recognition as interactive communications with the user are in progress, and return the vocabulary to a vocabulary which the voice information searching device has used according to a request from the user. This voice information searching device efficiently can search for the number of words which are objects to be recognized by selecting words which are objects to be recognized according to a history of the results of previous voice recognition and previous word searches.

Further, patent reference 2 discloses a voice recognition device which predicts the user's action to dynamically change a recognition dictionary. This voice recognition device holds a history of the user's actions, and predicts the user's action according to a time zone which the user performs each of the actions and which is derived from the history of the user's actions to update and change a vocabulary to be recognized. As a result, the voice recognition device narrows the number of words to be recognized according to the history of the user's actions.

A problem with patent reference 1 is, however, that because the voice information searching device selects words to be recognized according to a history of the results of previous voice recognition and previous word searches, the voice information searching device cannot narrow the number of words to be recognized, depending on the contents of interactive communications with the user, and therefore the time required to create a recognition dictionary during the interactive communications is lengthened.

Similarly, a problem with patent reference 2 is that the voice recognition device cannot narrow the number of words to be recognized, depending on the contents of the history of the user's actions, and therefore the time required to create a recognition dictionary is lengthened.

The present invention is made in order to solve the above-mentioned problems, and it is therefore an object of the present invention to provide a voice recognition device that can reduce the usable capacity of a storage area needed for storing a recognition dictionary created in advance while shortening the time required to create a recognition dictionary during interactive communications with the user.

### RELATED ART DOCUMENT

### Patent Reference

Patent reference 1: Japanese Unexamined Patent Application Publication No. Hei 7-219590
Patent reference 2: Japanese Unexamined Patent Application Publication No. 2002-341892

### SUMMARY OF THE INVENTION

In accordance with the present invention, there is provided a voice recognition device which performs voice recognition while switching between vocabularies to be recognized through an interaction, the voice recognition device including: a static creation unit for creating a recognition dictionary in advance for a vocabulary having words to be recognized whose number is equal to or larger than a threshold; a dynamic creation unit for creating a recognition dictionary for a vocabulary having words to be recognized whose number is smaller than the threshold in an interactive situation; and a voice recognition unit for performing voice recognition on an inputted voice by making reference to the recognition dictionary created by the static creation unit or the dynamic creation unit.

Because the voice recognition device in accordance with the present invention creates a recognition dictionary in advance for a vocabulary having words to be recognized whose number is equal to or larger than the threshold, and creates a recognition dictionary for a vocabulary having words to be recognized whose number is smaller than the threshold in an interactive situation, the voice recognition device provides an advantage of being able to reduce the amount of storage area used and needed for storing the recognition dictionary created in advance while shortening the time required to create the recognition dictionary during interactive communications with the user.

### BRIEF DESCRIPTION OF THE FIGURES

FIG. 1 is a block diagram showing the structure of a voice recognition device in accordance with Embodiment 1 of the present invention;

FIG. 2 is a block diagram showing the structure of a voice recognition device in accordance with Embodiment 2 of the present invention;

FIG. 3 is a block diagram showing the structure of a voice recognition device in accordance with Embodiment 3 of the present invention;

FIG. 4 is a flow chart showing a flow of a determining process carried out by a recognition dictionary dynamic creation determination unit in accordance with Embodiment 3;

FIG. 5 is a flow chart showing a flow of a determining process carried out by a recognition dictionary static creation determination unit in accordance with Embodiment 3;

FIG. 6 is a block diagram showing the structure of a voice recognition device in accordance with Embodiment 4 of the present invention; and

FIG. 7 is a block diagram showing the structure of a voice recognition device in accordance with Embodiment 5 of the present invention.

### EMBODIMENTS OF THE INVENTION

Hereafter, in order to explain this invention in greater detail, the preferred embodiments of the present invention will be described with reference to the accompanying drawings.

### Embodiment 1

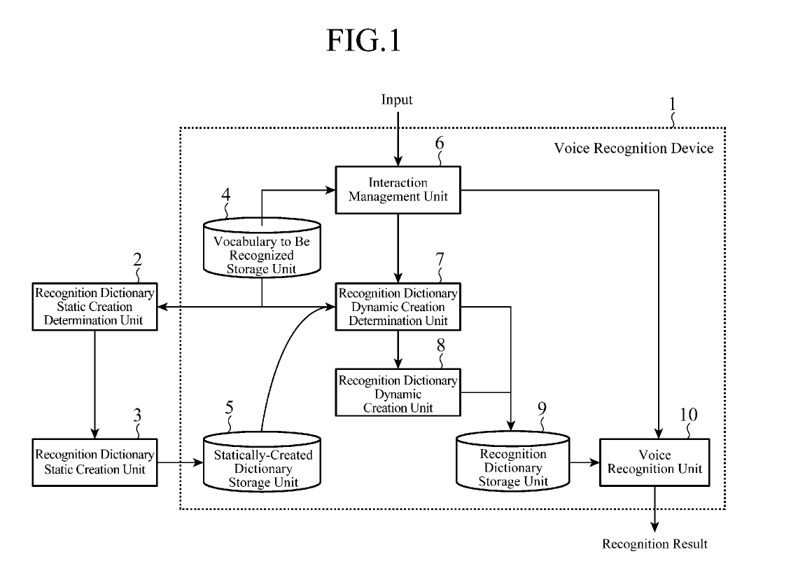

FIG. 1 is a block diagram showing the structure of a voice recognition device in accordance with Embodiment 1 of the present invention. The voice recognition device 1 in accordance with Embodiment 1 uses both a recognition dictionary which the voice recognition device creates in advance before performing voice recognition through interactive communications with a user, and a recognition dictionary which the voice recognition device creates while performing interactive communications with the user for voice recognition. In the present invention, a recognition dictionary which the voice recognition device creates so-called statically before performing voice recognition through interactive communications with the user is referred to as a “statically-created dictionary”, and a recognition dictionary which the voice recognition device creates so-called dynamically while performing interactive communications with the user is referred to as a “dynamically-created dictionary”.

A recognition dictionary static creation determination unit 2 is a component for determining whether or not there is a necessity to statically create a recognition dictionary using words each of which can be a target for voice recognition according to the number of words. A recognition dictionary statically creation unit (statically creation unit) 3 is a component for statically creating a recognition dictionary by using the words for which the recognition dictionary static creation determination unit 2 has determined a recognition dictionary needs to be created. The statically-created dictionary is created with no influence on the interactive communications with the user. Further, by creating the statically-created dictionary by using a large number of words each of which is an object to be recognized, the voice recognition device can use the statically-created dictionary at any time during the interactive communications with the user.

A vocabulary to be recognized storage unit 4 stores a vocabulary which can be an object to be recognized at each time of performing voice recognition. For example, in a case in which the present invention is applied to a car navigation system, and a function of performing voice recognition on an uttered address or the like is provided for the car navigation system, the names of prefectures, the names of cities, towns and villages each of which can be included in each prefecture, the names of wards and village sections each of which can be included in each city, town or village, etc. are stored in the vocabulary to be recognized storage unit 4 as the vocabulary which can be an object to be recognized.

A statically-created dictionary storage unit 5 stores the recognition dictionary (statically-created dictionary) created by the recognition dictionary static creation unit 3. An interaction management unit 6 is a component for providing an HMI (Human Machine Interface) using a not-shown input unit and a display unit, and for carrying out an interactive process of performing interactive communications with a user. For example, the interaction management unit 6 selects words each of which is a target for voice recognition (referred to as words to be recognized from here on) from the vocabulary to be recognized storage unit 4 according to information inputted by the user.

A recognition dictionary dynamic creation determination unit 7 is a component for determining whether or not there is a necessity to dynamically create a recognition dictionary for the words to be recognized corresponding to the voice recognition which is carried out by the voice recognition unit 10 according to whether or not a statically-created dictionary for the above-mentioned words to be recognized is stored in the statically-created dictionary storage unit 5.

A recognition dictionary dynamic creation unit (dynamic creation unit) 8 is a component for dynamically creating a recognition dictionary by using the words for which the recognition dictionary dynamic creation determination unit 7 has determined a recognition dictionary needs to be created.

For example, the recognition dictionary dynamic creation unit 8 creates the dynamically-created dictionary by using the words to be recognized which are selected by the interaction management unit 6, or words to be recognized which the voice recognition device acquires on line from outside the voice recognition device via a not-shown communication means. Because the dynamically-created dictionary is created dynamically by using the words to be recognized which are changed as the interactive communications with the user are in progress, the number of words to be recognized which are used for the dynamic dictionary creation is reduced compared with the number of words to be recognized which are used for the creation of the statically-created dictionary so that the time required to dynamically create the dictionary can be shortened.

The recognition dictionary storage unit 9 is a component for storing a recognition dictionary which is used for the voice recognition process carried out by the voice recognition unit 10, and the statically-created dictionary read from the statically-created dictionary storage unit 5 or the dynamically-created dictionary created by the recognition dictionary dynamic creation determination unit 7 is stored in the recognition dictionary storage unit. The voice recognition unit 10 is a component for carrying out voice recognition by using the recognition dictionary read from the recognition dictionary storage unit 9.

Further, the recognition dictionary static creation determination unit 2, the recognition dictionary static creation unit 3, the interaction management unit 6, the recognition dictionary dynamic creation determination unit 7, the recognition dictionary dynamic creation unit 8, and the voice recognition unit 10 can be implemented on a computer as a concrete means in which hardware and software work in cooperation with each other by causing the computer to execute a program for voice recognition according to the scope of the present invention.

In addition, the vocabulary to be recognized storage unit 4, the statically-created dictionary storage unit 5, and the recognition dictionary storage unit 9 can be constructed in a storage unit mounted in the above-mentioned computer, e.g. a hard disk drive unit, an external storage medium, or the like.

Next, the operation of the voice recognition device will be explained.

### (1) Creation of a Statically-Created Dictionary

First, the recognition dictionary static creation determination unit 2 determines whether or not there is a necessity to create a statically-created dictionary for each vocabulary stored in the vocabulary to be recognized storage unit 4.

At this time, for example, when the vocabulary being processed has a number of words for which the time required to dynamically create a recognition dictionary falls within a predetermined time interval, the recognition dictionary static creation determination unit determines that there is no necessity to create a statically-created dictionary, whereas when the vocabulary being processed has a number of words for which the time required to dynamically create a recognition dictionary exceeds the predetermined time interval, the recognition dictionary static creation determination unit determines that there is a necessity to create a statically-created dictionary.

As an alternative, the voice recognition device 1 can measure and store a dictionary creation time required to create a dictionary (a time required to create a dynamically-created dictionary) by using words to be recognized in each situation of performing voice recognition, and the recognition dictionary static creation determination unit 2 can determine that there is necessity to create a statically-created dictionary for a vocabulary for which the above-mentioned measured value stored in the voice recognition device 1 exceeds a predetermined time.

The recognition dictionary static creation unit 3 creates a statically-created dictionary by using a vocabulary for which the recognition dictionary static creation determination unit has determined there is necessity to create a statically-created dictionary, and which is read from the vocabulary to be recognized storage unit 4. In a method of creating a recognition dictionary, in a case in which each word in the vocabulary is provided as a text string, a reading (phonemes or the like) is created for the text string by using G2P (Grapheme to Phoneme), and is converted into data having a form which can be referred to by the voice recognition unit 10. For example, while converting each word into binary data in a form acceptable by the voice recognition unit 10, the recognition dictionary static creation unit performs a morphological analysis and word division as needed to produce language constraints.

The statically-created dictionary created by the recognition dictionary static creation unit 3 is stored in the statically-created dictionary storage unit 5. The statically-created dictionary storage unit 5 is constructed on a storage, such as a hard disk drive unit or a nonvolatile memory, for example. In a case of performing voice recognition on an address, the statically-created dictionary can be created by using, as a vocabulary to be recognized, words in all hierarchical layers in the hierarchical structure of words including the names of prefectures, the names of cities, towns and villages each of which can be included in each prefecture, and the names of wards and village sections each of which can be included in each city, town or village.

The statically-created dictionary can be created by a device disposed outside the voice recognition device 1 and stored in the statically-created dictionary storage unit 5 in a case of, for example, performing voice recognition on an address which is a word to be recognized which does not vary dynamically.

Further, the statically-created dictionary can be created at the time that the voice recognition device 1 is started or every time when the memory contents of the vocabulary to be recognized storage unit 4 which is a database for storing each vocabulary which can be an object to be recognized are updated.

### (2) Operation During Interactive Communications

When performing voice recognition through interactive communications with the user in the voice recognition device 1, the interaction management unit 6 selects words to be recognized from a vocabulary stored in the vocabulary to be recognized storage unit 4 one by one on the basis of a voice recognition situation specified by the user and a history of communications with the user.

For example, when carrying out voice recognition on an address, the interaction management unit 6 selects the names of prefectures as words to be recognized from the corresponding vocabulary stored in the vocabulary to be recognized storage unit 4 at the time of starting the voice recognition, and, after the user inputs a prefecture name, selects, as words to be recognized, the names of cities, wards, towns, and villages which are words belonging to this prefecture name from the vocabulary to be recognized storage unit 4. Thus, the interaction management unit 6 determines the words to be recognized and the number of the words through interactive communications with the user.

Next, the recognition dictionary dynamic creation determination unit 7 determines whether or not a statically-created dictionary using the words to be recognized determined by the interaction management unit 6 has been created, i.e. whether or not a statically-created dictionary using the words to be recognized is stored in the statically-created dictionary storage unit 5. When the statically-created dictionary about the words to be recognized has been created, the recognition dictionary dynamic creation determination unit 7 reads the statically-created dictionary from the statically-created dictionary storage unit 5, and stores the statically-created dictionary in the recognition dictionary storage unit 9 as a recognition dictionary which is used for a voice recognition process carried out by the voice recognition unit 10.

In contrast, when the statically-created dictionary about the words to be recognized has not been created, the recognition dictionary dynamic creation determination unit 7 commands the recognition dictionary dynamic creation unit 8 to create a dynamically-created dictionary about the words to be recognized. According to this command, the recognition dictionary dynamic creation unit 8 creates a dynamically-created dictionary about the words to be recognized and stores the dynamically-created dictionary in the recognition dictionary storage unit 9 as a recognition dictionary which is used for the voice recognition process carried out by the voice recognition unit 10. A method of creating the recognition dictionary is the same as the method of creating the statically-created dictionary which the above-mentioned recognition dictionary static creation unit 3 uses.

For example, in the case of carrying out voice recognition on an address, when the user selects a prefecture name as a word to be recognized as the interactive communications with the user are in progress, the recognition dictionary dynamic creation unit creates a dynamically-created dictionary for which the prefecture name is defined as a word to be recognized, and then creates a dynamically-created dictionary for which the names of cities, wards, towns, and villages are defined as words to be recognized.

More specifically, as the interactive communications with the user are in progress, words in all hierarchical layers in the hierarchical structure of words including the prefecture name, the names of cities, towns and villages each of which can be included in the prefecture, and the names of wards and village sections each of which can be included in each city, town or village are selected as words to be recognized for the dynamically-created dictionary.

The voice recognition unit 10 performs voice recognition on the inputted voice by using the recognition dictionary stored in the recognition dictionary storage unit 9. In a method of performing voice recognition, the voice recognition unit performs HMM (Hidden Markov Model), DP matching, or the like on the inputted voice, for example, to determine the likelihood of each word to be recognized which is registered in the recognition dictionary for the inputted voice, and outputs the word having the greatest likelihood (probability) as a voice recognition result.

As an alternative, instead of outputting the word having the greatest likelihood, the voice recognition unit can output the N top-ranked words having a greater likelihood, among the words to be recognized, as voice recognition results.

As mentioned above, because the voice recognition device according to this Embodiment 1 creates a recognition dictionary (statically-created dictionary) in advance for a vocabulary including words to be recognized whose number is equal to or larger than a threshold, and creates a recognition dictionary (dynamically-created dictionary) for a vocabulary including words to be recognized whose number is smaller than the threshold in an interaction situation, the voice recognition device can reduce the amount of storage area used and needed for storing the recognition dictionary created in advance while shortening the time required to create the recognition dictionary during interactive communications with the user.

### Embodiment 2

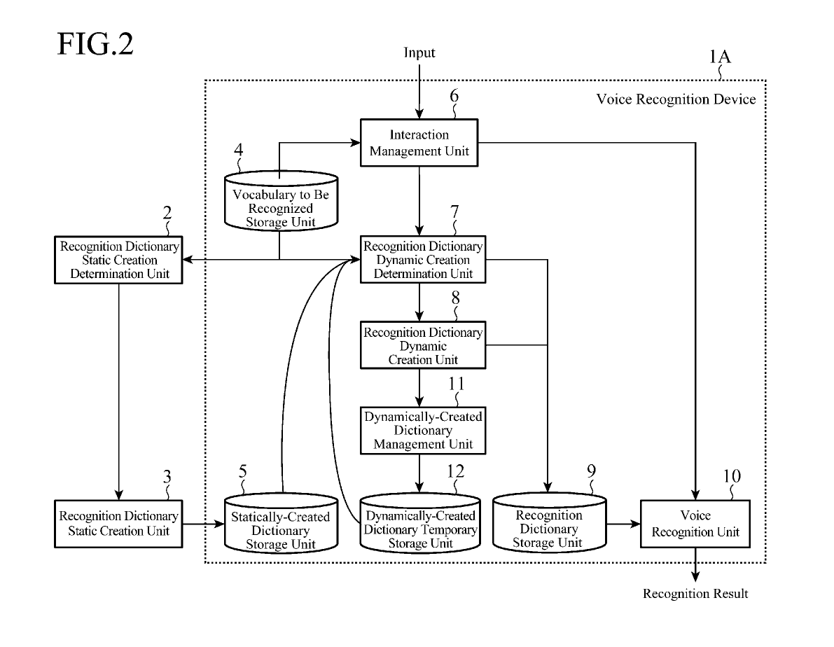

FIG. 2 is a block diagram showing the structure of a voice recognition device in accordance with Embodiment 2 of the present invention. As shown in FIG. 2, in addition to the structure of the voice recognition device 1 shown in above-mentioned Embodiment 1, the voice recognition device 1A in accordance with Embodiment 2 is provided with a dynamically-created dictionary management unit (storage management unit) 11 and a dynamically-created dictionary temporary storage unit (temporary storage unit) 12. In FIG. 2, the same components as those shown in FIG. 1 or like components are designated by the same reference numerals as those shown in the figure, and the explanation of the components will be omitted hereafter.

The dynamically-created dictionary management unit 11 is a component for managing a process of storing a dynamically-created dictionary created by a recognition dictionary dynamic creation unit 8 in the dynamically-created dictionary temporary storage unit 12. The dynamically-created dictionary temporary storage unit 12 temporarily stores a dynamically-created dictionary which the dynamically-created dictionary management unit 11 has determined is to be stored therein.

Further, a recognition dictionary static creation determination unit 2, a recognition dictionary static creation unit 3, an interaction management unit 6, a recognition dictionary dynamic creation determination unit 7, the recognition dictionary dynamic creation unit 8, a voice recognition unit 10, and the dynamically-created dictionary management unit 11 can be implemented on a computer as a concrete means in which hardware and software work in cooperation with each other by causing the computer to execute a program for voice recognition according to the scope of the present invention.

In addition, a vocabulary to be recognized storage unit 4, a statically-created dictionary storage unit 5, a recognition dictionary storage unit 9, and the dynamically-created dictionary temporary storage unit 12 can be constructed in a storage unit mounted in the above-mentioned computer, e.g. a hard disk drive unit, an external storage medium, or the like.

Next, the operation of the voice recognition device will be explained.

When a dynamically-created dictionary is newly created by the recognition dictionary dynamic creation unit 8, the dynamically-created dictionary management unit 11 determines whether the storage capacity of the dynamically-created dictionary temporary storage unit 12 exceeds a predetermined capacity. When the storage capacity of the dynamically-created dictionary temporary storage unit 12 is less than the predetermined capacity, the dynamically-created dictionary management unit 11 stores the newly created dynamically-created dictionary in the dynamically-created dictionary temporary storage unit 12.

In contrast, when the storage capacity of the dynamically-created dictionary temporary storage unit 12 exceeds the predetermined capacity, the dynamically-created dictionary management unit 11 determines a dynamically-created dictionary which is to be deleted from the dynamically-created dictionary temporary storage unit 12 on the basis of a history or frequency of use of each of dynamically-created dictionaries which are stored in the dynamically-created dictionary temporary storage unit 12, and deletes the dynamically-created dictionary.

For example, the dynamically-created dictionary management unit determines the dynamically-created dictionary whose date and time of last use is the oldest as the target to be deleted.

As an alternative, the dynamically-created dictionary management unit can determine the dynamically-created dictionary having the longest average length of intervals at which the dynamically-created dictionary is used from among dynamically-created dictionaries which have been used when the voice recognition device 1A has been operating, as the target to be deleted.

After deleting the dynamically-created dictionary stored in the dynamically-created dictionary temporary storage unit 12, the dynamically-created dictionary management unit 11 stores the newly created dynamically-created dictionary in the dynamically-created dictionary temporary storage unit 12.

In addition, the dynamically-created dictionary management unit 11 can manage a history or frequency of use of each of the recognition dictionaries stored in the statically-created dictionary storage unit 5 and the recognition dictionary storage unit 9, in addition to the management of the dynamically-created dictionaries stored in the dynamically-created dictionary temporary storage unit 12, and can perform an operation of storing a dictionary in the statically-created dictionary storage unit 5 and the recognition dictionary storage unit 9 according to the history or frequency of use of each of the recognition dictionaries in the same way as that mentioned above.

When no recognition dictionary including a vocabulary to be recognized is stored in both the statically-created dictionary storage unit 5 and the dynamically-created dictionary temporary storage unit 12, the recognition dictionary dynamic creation determination unit 7 determines that there is a necessity for the recognition dictionary dynamic creation unit 8 to create a dynamically-created dictionary including the vocabulary to be recognized.

Further, when a recognition dictionary including the vocabulary to be recognized is stored in either the statically-created dictionary storage unit 5 or the dynamically-created dictionary temporary storage unit 12, the recognition dictionary dynamic creation determination unit 7 reads the recognition dictionary and stores this recognition dictionary in the recognition dictionary storage unit 9. The voice recognition unit 10 performs voice recognition on the inputted voice by using the recognition dictionary stored in the recognition dictionary storage unit 9.

Thus, the voice recognition device makes the dynamically-created dictionary stored temporarily in the dynamically-created dictionary temporary storage unit 12 available as a recognition dictionary for the vocabulary to be recognized. As a result, there is no necessity to newly create a dynamically-created dictionary as occasion demands as the interactive communications with the user are in progress, and the processing load required to create the dynamically-created dictionary can be reduced.

As mentioned above, because the voice recognition device according to this Embodiment 2 includes the dynamically-created dictionary temporary storage unit 12 for temporarily storing a recognition dictionary (dynamically-created dictionary) created by the recognition dictionary dynamic creation unit 8, and the dynamically-created dictionary management unit 11 for managing whether or not to store the recognition dictionary in the dynamically-created dictionary temporary storage unit 12 according to the usage status of each of dynamically-created dictionaries, the voice recognition device can reduce the amount of computation required for the dictionary creation while reducing the amount of storage used to store the recognition dictionary to a minimum.

### Embodiment 3

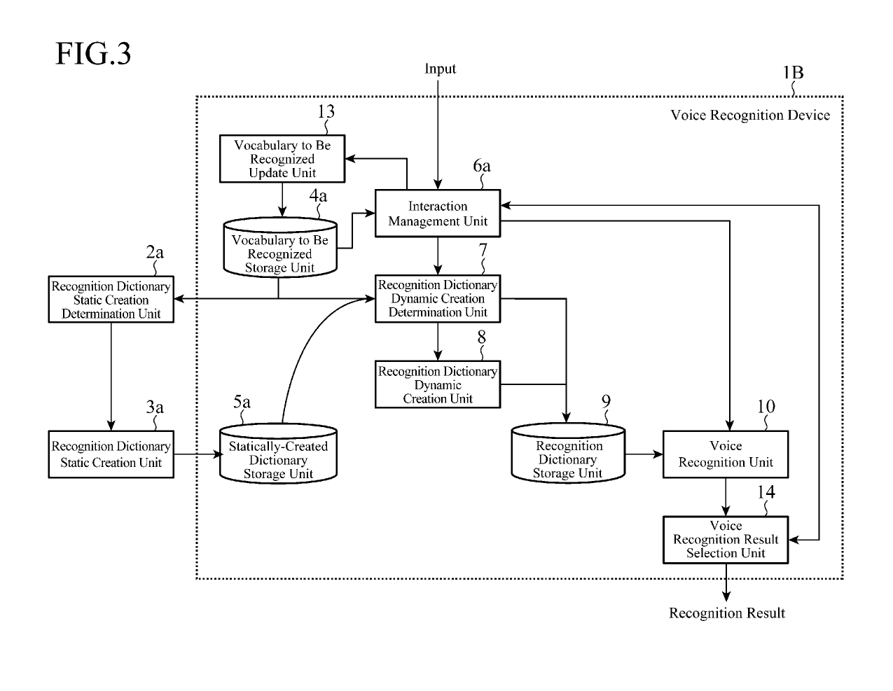

FIG. 3 is a block diagram showing the structure of a voice recognition device in accordance with Embodiment 3 of the present invention. The voice recognition device 1B in accordance with Embodiment 3 carries out voice recognition on a voice while switching between vocabularies to be recognized through interactive communications with a user, and it is assumed that the voice recognition device changes words to be recognized for each interaction situation (each situation where the voice recognition device carries out voice recognition) by tracing the hierarchical structure of a vocabulary including the words in such a case where the voice recognition device makes a search for a musical piece (e.g. a search through all devices for a music piece, a search for a musical piece after selecting an artist, or a search for a musical piece after selecting an album).

As shown in FIG. 3, the voice recognition device 1B is provided with a recognition dictionary static creation determination unit 2a, a recognition dictionary static creation unit 3a, a vocabulary to be recognized storage unit 4a, a statically-created dictionary storage unit 5a, an interaction management unit 6a, a recognition dictionary dynamic creation determination unit 7, a recognition dictionary dynamic creation unit 8, a recognition dictionary storage unit 9, a voice recognition unit 10, a vocabulary to be recognized update unit 13, and a voice recognition result selection unit 14.

The recognition dictionary static creation determination unit 2a is a component for determining whether or not there is a necessity to statically create a recognition dictionary by using a vocabulary in the vocabulary to be recognized storage unit 4a according to whether or not the vocabulary stored in the vocabulary to be recognized storage unit 4a has been updated. The recognition dictionary static creation unit (static creation unit) 3a is a component for, when the recognition dictionary static creation determination unit 2a determines that there is a necessity to statically create a recognition dictionary by using a vocabulary in the vocabulary to be recognized storage unit 4a, statically creating a recognition dictionary by using the vocabulary.

The vocabulary to be recognized storage unit 4a stores words each of which can be an object to be recognized in a situation where the voice recognition device carries out voice recognition, and its memory contents are updated by the vocabulary to be recognized update unit 13. The statically-created dictionary storage unit 5a stores the statically-created dictionary created by the recognition dictionary static creation unit 3a.

The interaction management unit 6a is a component for providing an HMI for the user by using a not-shown input unit and a not-shown display unit, and carrying out a process of performing interactive communications with the user, and selects a vocabulary to be recognized from the vocabulary to be recognized storage unit 4a. The recognition dictionary dynamic creation determination unit 7 is a component for determining whether or not there is a necessity to statically create a recognition dictionary for a vocabulary to be recognized corresponding to voice recognition which is carried out by the voice recognition unit 10 according to whether or not a statically-created dictionary for the vocabulary to be recognized is stored in the statically-created dictionary storage unit 5a.

The recognition dictionary dynamic creation unit 8 is a component for dynamically creating a recognition dictionary by using the vocabulary for which the recognition dictionary dynamic creation determination unit 7 has determined there is a necessity to create a recognition dictionary. The recognition dictionary storage unit 9 stores a recognition dictionary which the voice recognition unit 10 uses for the voice recognition process, and the statically-created dictionary read from the statically-created dictionary memory 5a or the dynamically-created dictionary created by the recognition dictionary dynamic creation determination unit 7 is stored in the recognition dictionary storage unit. Further, the voice recognition unit 10 is a component for carrying out voice recognition by using the recognition dictionary read from the recognition dictionary storage unit 9.

The vocabulary to be recognized update unit 13 is a component for updating a vocabulary to be recognized which is stored in the vocabulary to be recognized storage unit 4a. For example, in a case in which the voice recognition device is used in such a music search system as mentioned above, when a portable music player is connected to the voice recognition device, the vocabulary to be recognized update unit 13 reads the whole of a vocabulary including a dictionary containing all music titles, a dictionary containing all artist names, and a dictionary containing all album titles from a memory of the portable music player to update the corresponding vocabulary stored in the vocabulary to be recognized storage unit 4a.

The voice recognition result selection unit 14 is a component for selecting only recognition result candidates corresponding to the vocabulary to be recognized selected by the interaction management unit 6a from among recognition result candidates provided by the voice recognition unit 10 to output the recognition result candidates selected thereby as results of the voice recognition.

The recognition dictionary static creation determination unit 2a, the recognition dictionary static creation unit 3a, the interaction management unit 6a, the recognition dictionary dynamic creation determination unit 7, the recognition dictionary dynamic creation unit 8, the voice recognition unit 10, the vocabulary to be recognized update unit 13, and the voice recognition result selection unit 14 can be implemented on a computer as a concrete means in which hardware and software work in cooperation with each other by causing the computer to execute a program for voice recognition according to the scope of the present invention.

In addition, the vocabulary to be recognized storage unit 4a, the statically-created dictionary storage unit 5a, and the recognition dictionary storage unit 9 can be constructed in a storage unit mounted in the above-mentioned computer, e.g. a hard disk drive unit, an external storage medium, or the like.

Next, the operation of the voice recognition device will be explained.

### (1a) Creation of a Statically-Created Dictionary

The voice recognition device 1B in accordance with Embodiment 3 is suitable for a system which traces the hierarchical structure of a vocabulary to be recognized to narrow the vocabulary to be recognized for each interaction situation in such a case where the voice recognition device makes a search for a musical piece (e.g. a search through all devices for a music piece, a search for a musical piece after selecting an artist, or a search for a musical piece after selecting an album), among systems each of which carries out voice recognition while switching between vocabularies to be recognized as interactive communications with the user are in progress.

In this system, when a vocabulary to be recognized is changed, the vocabulary to be recognized update unit 13 updates the vocabulary stored in the vocabulary to be recognized storage unit 4a.

In this case, as times when a vocabulary to be recognized is changed, a time when an external portable music player is connected to or disconnected from the voice recognition device 1B, and a time when a CD is inserted into or ejected from the voice recognition device 1B can be provided, for example.

The recognition dictionary static creation determination unit 2a selects a statically-created dictionary which is to be created at a time when a vocabulary to be recognized stored in the vocabulary to be recognized storage unit 4a is updated. For example, in a case in which the voice recognition device is used in such a music search system as mentioned above, when a portable music player is connected to the voice recognition device, a vocabulary stored in the vocabulary to be recognized storage unit 4a is updated with a vocabulary including music titles, artist names, and album names, and dictionaries including the whole of the vocabulary stored in the vocabulary to be recognized storage unit 9a, i.e. a dictionary including a dictionary containing all music titles, a dictionary containing all artist names, and a dictionary containing all album titles are selected as statically-created dictionaries.

The recognition dictionary static creation unit 3a creates the statically-created dictionaries which are selected by the recognition dictionary static creation determination unit 2a, and stores the dictionaries in the statically-created dictionary storage unit 5a, like in the case of above-mentioned Embodiment 1.

### (2a) Operation During Interactive Communications

At the time of voice recognition, the interaction management unit 6a determines a vocabulary to be recognized and the number Nn of words in the vocabulary through interactive communications with the user. These pieces of information (the vocabulary to be recognized and the number Nn of words in the vocabulary) are outputted from the interaction management unit 6a to the recognition dictionary dynamic creation determination unit 7.

The recognition dictionary dynamic creation determination unit 7 determines whether to cause the recognition dictionary dynamic creation unit 8 to newly create a recognition dictionary or to use the statically-created dictionaries stored in the statically-created dictionary storage unit 5a as recognition dictionaries by using a relation of inclusion of words to be recognized of the statically-created dictionaries and the percentage of the number of words to be recognized which are stored in the statically-created dictionary storage unit 5a. For example, the recognition dictionary dynamic creation determination unit performs this determination in the following way.

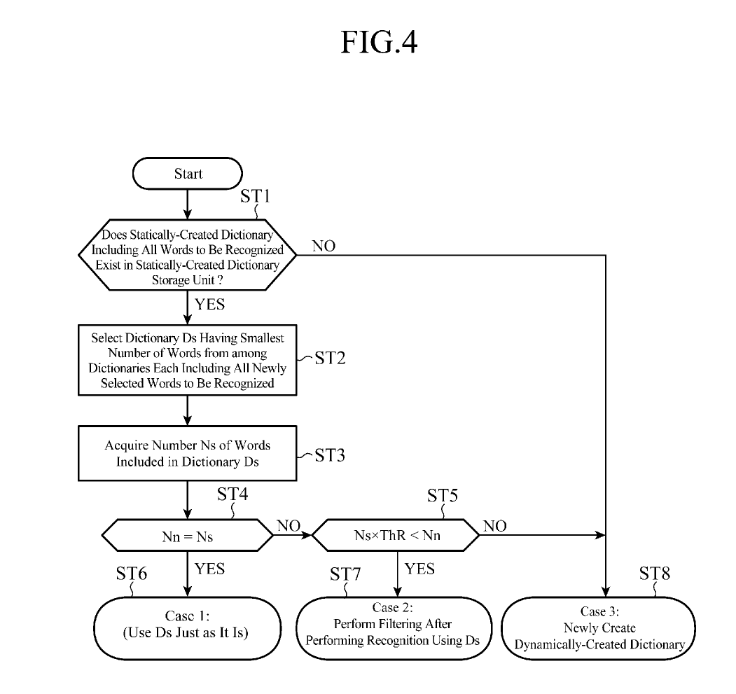

FIG. 4 is a flow chart showing a flow of the determining process carried out by the recognition dictionary dynamic creation determination unit 7 in accordance with Embodiment 3.

First, the recognition dictionary dynamic creation determination unit 7 determines whether one or more statically-created dictionaries including all of the vocabulary to be recognized which the interaction management unit 6a has selected newly through interactive communications with the user exist in the statically-created dictionary storage unit 5a (step ST1). For example, when the user selects a genre through interactive communications with the voice recognition device, and sets the artist names included in the selected genre as the vocabulary for the current recognition situation, the recognition dictionary dynamic creation determination unit determines that one or more statically-created dictionaries including all of the vocabulary exist in the statically-created dictionary storage unit because the artist name dictionary currently selected is included in the dictionary containing all the artist names.

When no statically-created dictionaries as mentioned above exist in the statically-created dictionary storage unit 5a (when NO in step ST1), the recognition dictionary dynamic creation determination unit 7 determines that the recognition dictionary dynamic creation unit 8 needs to newly create a dynamically-created dictionary including the vocabulary to be recognized selected by the interaction management unit 6a (Case3 in step ST8). After that, the recognition dictionary dynamic creation determination unit 7 commands the recognition dictionary dynamic creation unit 8 to create a dynamically-created dictionary about the vocabulary to be recognized. According to this command, the recognition dictionary dynamic creation unit 8 creates a dynamically-created dictionary about the vocabulary to be recognized and stores this dynamically-created dictionary in the recognition dictionary storage unit 9 as a recognition dictionary which is used for a voice recognition process carried out by the voice recognition unit 10.

In contrast, when one or more statically-created dictionaries as mentioned above exist in the statically-created dictionary storage unit 5a (when YES in step ST1), the recognition dictionary dynamic creation determination unit 7 selects a dictionary Ds having the smallest number of words from among the one or more statically-created dictionaries which are stored in the statically-created dictionary storage unit 5a and include all of the vocabulary to be recognized which the interaction management unit 6a has selected newly (step ST2).

Next, the recognition dictionary dynamic creation determination unit 7 acquires the number Ns of words included in the dictionary Ds (step ST3).

After that, the recognition dictionary dynamic creation determination unit 7 compares the number Nn of words in the vocabulary to be recognized which the interaction management unit 6a has selected newly through interactive communications with the user with the number Ns of words included in the dictionary Ds to determine whether or not the two numbers of words are equal to each other (step ST4). When the two numbers Nn and Ns of words are equal to equal to each other (when YES in step ST4), the recognition dictionary dynamic creation determination unit 7 determines that the voice recognition device should use the dictionary Ds selected from the statically-created dictionary storage unit 5a just as it is, and stores the dictionary Ds in the recognition dictionary storage unit 9 as a recognition dictionary (Case1 in step ST6).

In contrast, when the two numbers Nn and Ns of words are different from each other (when NO in step ST4), the recognition dictionary dynamic creation determination unit 7 determines whether or not a value which the recognition dictionary dynamic creation determination unit calculates by multiplying the number Ns of words included in the dictionary Ds by a predetermined ratio ThR (e.g. 0.1) is smaller than the number Nn of words included in the vocabulary to be recognized which the interaction management unit 6a has selected newly (Ns×ThR<Nn) (step ST5).

When the value of (Ns×ThR) is smaller than the number Nn of words (when YES in step ST5), the recognition dictionary dynamic creation determination unit 7 shifts to a process (Case2) of step ST7.

The recognition dictionary dynamic creation determination unit 7, in step ST7, stores the dictionary Ds in the recognition dictionary storage unit 9 as a recognition dictionary. The voice recognition unit 10 carries out voice recognition on the user's utterance (an inputted voice) by using this dictionary Ds, and outputs the N top-ranked recognition result candidates having a higher probability (N top-ranked recognition result candidates having a greater likelihood) to the voice recognition result selection unit 14.

The voice recognition result selection unit 14 selects only the recognition result candidates included in the vocabulary to be recognized which the interaction management unit 6a has selected newly from among the recognition result candidates acquired by the voice recognition unit 10 (filtering), and outputs the recognition result candidates selected thereby as results of voice recognition.

When the value of (Ns×ThR) is equal to or larger the number Nn of words (when NO in step ST5), the recognition dictionary dynamic creation determination unit 7 determines that the recognition dictionary dynamic creation unit 8 needs to newly create a dynamically-created dictionary including the vocabulary to be recognized selected by the interaction management unit 6a, and shifts to a process (Case3) of step ST8.

When the determination result of the recognition dictionary dynamic creation determination unit 7 shows Case1 or Case3, the voice recognition result selection unit 14 outputs the recognition result candidates outputted from the voice recognition unit 10 as recognition results. In contrast, when the determination result of the recognition dictionary dynamic creation determination unit 7 shows Case2, the voice recognition result selection unit 14 selects and outputs only the recognition result candidates included in the vocabulary to be recognized which the interaction management unit 6a has selected newly from among the recognition result candidates outputted from the voice recognition unit 10.

By creating a dictionary including the whole of the vocabulary in advance and storing the dictionary in a storage in this way, the voice can reduce the time required to create a recognition dictionary at the time of an update of the recognition dictionary.

Further, when a recognition dictionary which includes the vocabulary to be recognized and whose percentage of the number of words to be recognized therein is equal to or larger a predetermined percentage exists, the voice recognition device performs voice recognition using the dictionary, and selects only the recognition result candidates included in the vocabulary to be recognized from all the recognition result candidates and outputs the recognition result candidates as recognition results. By doing in this way, the voice recognition device can reduce the frequency with which to create a dictionary during interactive communications with the user while suppressing the influence on the recognition rate to a minimum.

Although the case in which the recognition dictionary static creation determination unit 2a determines a recognition dictionary for the whole of the vocabulary as a target for creation in advance is shown in the above-mentioned explanation, the voice recognition device can carry out the determination in the following way.

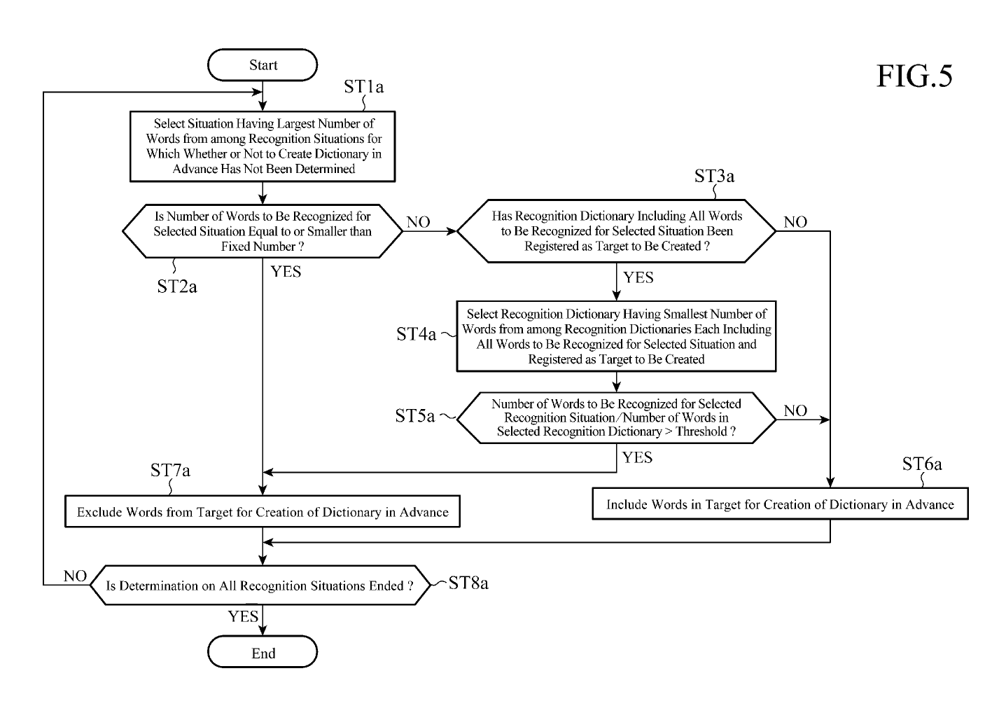

FIG. 5 is a flow chart showing a flow of the determining process carried out by the recognition dictionary static creation determination unit 2a in accordance with Embodiment 3.

First, the recognition dictionary static creation determination unit 2a refers to the memory contents of the vocabulary to be recognized storage unit 4a for each interaction situation where the voice recognition device carries out voice recognition (referred to as a recognition situation from here on) and determines a vocabulary to be recognized and the number of words in the vocabulary for each recognition situation. At this time, the recognition dictionary static creation determination unit 2a selects a recognition situation having the largest number of words in the vocabulary to be recognized from among recognition situations for which the recognition dictionary static creation determination unit has not determined whether or not to create a recognition dictionary (statically-created dictionary) for the vocabulary to be recognized (step ST1a).

The recognition dictionary static creation determination unit 2a then determines whether or not the number of words in the vocabulary to be recognized for the recognition situation selected in step ST1a is equal to or smaller than a fixed number (step ST2a). When the number of words in the vocabulary to be recognized exceeds the fixed number (when NO in step ST2a), the recognition dictionary static creation determination unit shifts to a process of step ST3a. In contrast, when the number of words in the vocabulary to be recognized is equal to or smaller than the fixed number (when YES in step ST2a), the recognition dictionary static creation determination unit shifts to a process of step ST7a.

The recognition dictionary static creation determination unit 2a, in step ST3a, determines whether or not the recognition dictionary including all of the vocabulary to be recognized for the recognition situation selected in step ST1a has been registered therein as the target for creation in advance. When the recognition dictionary including all of the vocabulary to be recognized has been registered therein (when YES in step ST3a), the recognition dictionary static creation determination unit shifts to a process of step ST4a. In contrast, when the recognition dictionary including all of the vocabulary to be recognized has been not registered therein (when NO in step ST3a), the recognition dictionary static creation determination unit shifts to a process of step ST6a.

The recognition dictionary static creation determination unit 2a selects the recognition dictionary having the smallest number of words from among the recognition dictionaries each including all of the vocabulary to be recognized for the recognition situation selected in step ST1a and registered as the target for creation in advance (step ST4a).

The recognition dictionary static creation determination unit 2a then determines whether a value which the recognition dictionary static creation determination unit calculates by dividing the number of words in the vocabulary to be recognized for the recognition situation selected in step ST1a by the number of words in the recognition dictionary selected in step ST4a exceeds a predetermined threshold (whether or not the value is larger than a fixed ratio?) (step ST5a).

When the value which the recognition dictionary static creation determination unit calculates by dividing the number of words in the vocabulary to be recognized for the recognition situation selected in step ST1a by the number of words in the recognition dictionary selected in step ST4a is equal to or smaller than the above-mentioned predetermined threshold (when NO in step ST5a), the recognition dictionary static creation determination unit 2a shifts to the process of step ST6a. In contrast, when the value exceeds the above-mentioned threshold (when YES in step ST5a), the recognition dictionary static creation determination unit shifts to the process of step ST7a.

The recognition dictionary static creation determination unit 2a, in step ST6a, registers the recognition dictionary including all of the vocabulary to be recognized for the recognition situation selected in step ST1a as the target for creation in advance.

In contrast, when the ratio of the number of words in the vocabulary to be recognized for the recognition situation selected in step ST1a to the number of words in the recognition dictionary selected in step ST4a exceeds the above-mentioned threshold, i.e. when the number of words is too small for creating a statically-created dictionary in advance, the recognition dictionary static creation determination unit excludes the recognition dictionary including all of the vocabulary to be recognized for the recognition situation from the target for creation in advance (step ST7a).

After completing the process of step ST6a or step ST7a, the recognition dictionary static creation determination unit 2a determines whether the recognition dictionary static creation determination unit has carried out the above-mentioned processing for all the recognition situations for which the recognition dictionary static creation determination unit has not determined whether or not there is a necessity to create a statically-created dictionary (step ST8a). When not having completed the processing on all the recognition situations, the recognition dictionary static creation determination unit returns to the process of step ST1a, whereas when having completed the processing on all the recognition situations, the recognition dictionary static creation determination unit ends the processing.

As mentioned above, in the voice recognition device according to this Embodiment 3, the recognition dictionary static creation unit 3a creates a recognition dictionary for each of all vocabularies which is an object to be recognized, and the recognition dictionary dynamic creation unit 8 creates a recognition dictionary for a vocabulary selected as an object to be recognized in an interactive situation. By creating only a recognition dictionary for each of all the vocabularies in advance, the voice recognition device can reduce the time required to create a recognition dictionary at the time of an update of the dictionary.

Further, according to this Embodiment 3, when the recognition dictionary static creation unit 3a creates a recognition dictionary which includes a vocabulary selected as an object to be recognized in an interactive situation and whose percentage of the number of words to be recognized therein is equal to or larger a predetermined percentage, the recognition dictionary dynamic creation unit 8 does not create a recognition dictionary for the vocabulary in the interactive situation, and the voice recognition unit 10 carries out voice recognition on the inputted voice by making reference to the recognition dictionary created by the recognition dictionary static creation unit 3a, and outputs recognition result candidates, among a plurality of top-ranked recognition result candidates having a greater recognition likelihood, which are included in the vocabulary which is the current object to be recognized as recognition results.

By doing in this way, the voice recognition device can reduce the frequency with which to create a dictionary during interactive communications with the user while suppressing the influence on the recognition rate to a minimum.

In addition, according to this Embodiment 3, because when the recognition dictionary static dictionary creation determination unit 2a makes such a determination as shown in FIG. 5, the recognition dictionary static creation unit 3a creates a recognition dictionary for a vocabulary which is an object to be recognized in advance in such a way that the number of words to be recognized exceeds a predetermined number in each interactive situation, and the number of words to be recognized in the interactive situation is equal to or smaller than a predetermined percentage of a total number of words in the recognition dictionary, the voice recognition device can reduce the waiting time for the user which results from the creation of a dictionary during interactive communications with the user while suppressing the increase in the time required to create a recognition dictionary at the time of an update of the dictionary to a minimum.

### Embodiment 4

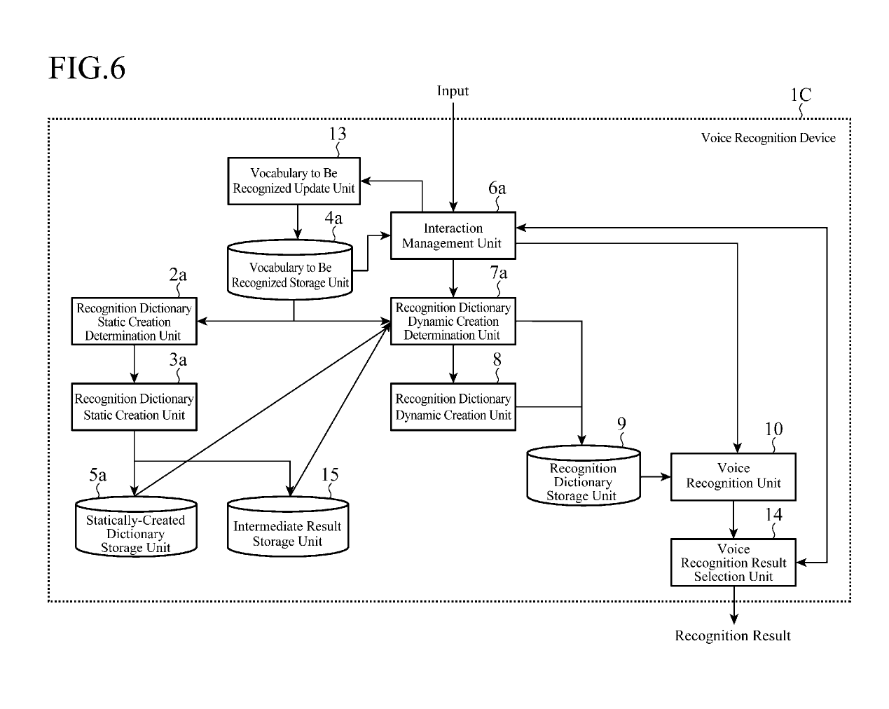

FIG. 6 is a block diagram showing the structure of a voice recognition device in accordance with Embodiment 4 of the present invention. As shown in FIG. 6, the voice recognition device 1C in accordance with Embodiment 4 is provided with an intermediate result storage unit 15 in addition to the structure of the voice recognition device 1B shown in above-mentioned Embodiment 3, while a recognition dictionary dynamic creation determination unit 7a operates in a way different from that in accordance with above-mentioned Embodiment 3. In FIG. 6, the same components as those shown in FIG. 3 or like components are designated by the same reference numerals as those shown in the figure, and the explanation of the components will be omitted hereafter.

When creating a statically-created dictionary from a vocabulary to be recognized, a recognition dictionary static creation unit 3a stores dictionary creation intermediate results of determining the language of the vocabulary to be recognized, carrying out a converting process of converting each written word into a spoken word, and so on in the intermediate result storage unit 15 as intermediate results.

When commanding a recognition dictionary dynamic creation unit 8 to create a dynamically-created dictionary from the vocabulary to be recognized which is commonly used for the statically-created dictionary stored in a statically-created dictionary storage unit 5a, the recognition dictionary dynamic creation determination unit 7a reads the intermediate results associated with the vocabulary and stored in the intermediate result storage unit 15, and outputs the intermediate results to the recognition dictionary dynamic creation unit 8. As a result, the recognition dictionary dynamic creation unit 8 creates a dynamically-created dictionary by using the intermediate results.

As mentioned above, because the voice recognition device according to this Embodiment 4 has the intermediate result storage unit 15 for storing intermediate results of determining the language of a vocabulary to be recognized which is acquired when creating a statically-created dictionary, and carrying out a converting process of converting each written word into a spoken word as intermediate results, the voice recognition device can reduce the time required to create a dynamically-created dictionary, and reduce the waiting time for the user which results from the creation of a dictionary during interactive communications with the user.

### Embodiment 5

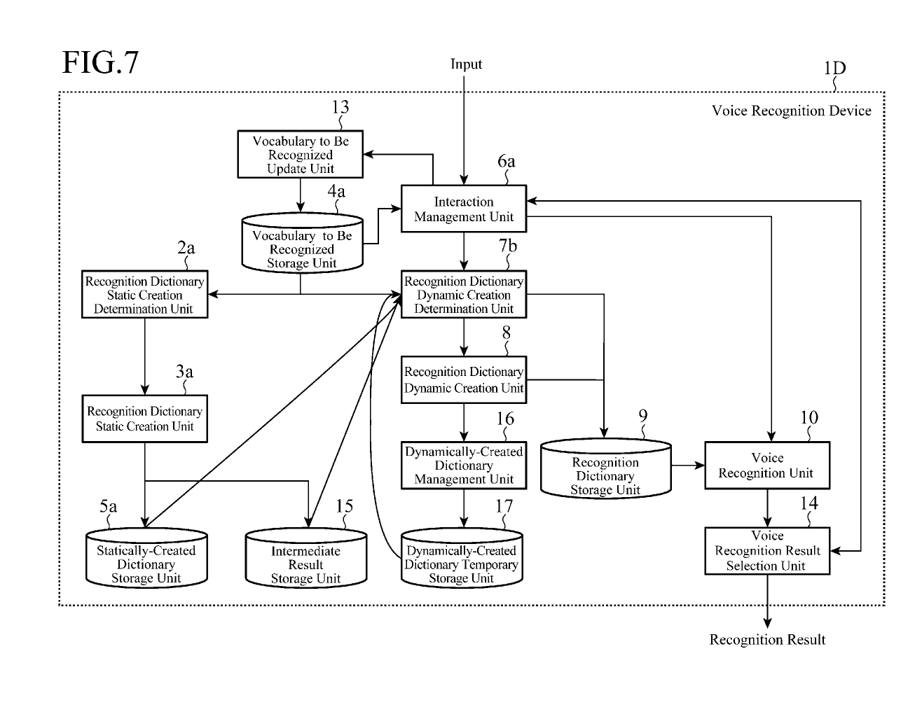

FIG. 7 is a block diagram showing the structure of a voice recognition device in accordance with Embodiment 5 of the present invention. As shown in FIG. 7, the voice recognition device 1D in accordance with Embodiment 5 additionally includes a dynamically-created dictionary management unit (storage management part) 16 and a dynamically-created dictionary temporary storage unit (temporary storage unit) 17 in addition to the structure of the voice recognition device 1C shown in above-mentioned Embodiment 4, while a recognition dictionary dynamic creation determination unit 7b operates in a way different from that in accordance with above-mentioned Embodiment 4.

In FIG. 7, the same components as those shown in FIG. 6 or like components are designated by the same reference numerals as those shown in the figure, and the explanation of the components will be omitted hereafter.

The dynamically-created dictionary management unit 16 is a component for determining whether or not to temporarily store a recognition dictionary dynamically created by a recognition dictionary dynamic creation unit 8 in the dynamically-created dictionary temporary storage unit 17.

The dynamically-created dictionary temporary storage unit 17 temporarily stores the dynamically-created dictionary which the dynamically-created dictionary management unit 16 has determined is a storage object.

Next, the operation of the voice recognition device will be explained.

When a dynamically-created dictionary is newly created by the recognition dictionary dynamic creation unit 8, the dynamically-created dictionary management unit 16 determines whether the storage capacity of the dynamically-created dictionary temporary storage unit 17 exceeds a predetermined capacity. When the storage capacity of the dynamically-created dictionary temporary storage unit 17 is less than the predetermined capacity, the dynamically-created dictionary management unit 16 stores the newly created dynamically-created dictionary in the dynamically-created dictionary temporary storage unit 17.

In contrast, when the storage capacity of the dynamically-created dictionary temporary storage unit 17 exceeds the predetermined capacity, the dynamically-created dictionary management unit 16 determines a dynamically-created dictionary which is to be deleted from the dynamically-created dictionary temporary storage unit 16 on the basis of a history or frequency of use of each of dynamically-created dictionaries which are stored in the dynamically-created dictionary temporary storage unit 17, and deletes the dynamically-created dictionary. For example, the dynamically-created dictionary management unit determines the dynamically-created dictionary whose date and time of last use is the oldest as the target to be deleted. As an alternative, the dynamically-created dictionary management unit can determine the dynamically-created dictionary having the longest average length of intervals at which the dynamically-created dictionary is used from among dynamically-created dictionaries which have been used when the voice recognition device 1D has been operating, as the target to be deleted.

After deleting the dynamically-created dictionary stored in the dynamically-created dictionary temporary storage unit 17, the dynamically-created dictionary management unit 16 stores the newly created dynamically-created dictionary in the dynamically-created dictionary temporary storage unit 17.

In addition, the dynamically-created dictionary management unit 16 can manage a history or frequency of use of each of the recognition dictionaries stored in a statically-created dictionary storage unit 5a and a recognition dictionary storage unit 9, in addition to the management of the dynamically-created dictionaries stored in the dynamically-created dictionary temporary storage unit 17, and can perform an operation of storing a dictionary in the statically-created dictionary storage unit 5a and the recognition dictionary storage unit 9 according to the history or frequency of use of each of the recognition dictionaries in the same way as that mentioned above.

When no recognition dictionary including a vocabulary to be recognized is stored in both the statically-created dictionary storage unit 5a and the dynamically-created dictionary temporary storage unit 17, the recognition dictionary dynamic creation determination unit 7b determines that there is a necessity for the recognition dictionary dynamic creation unit 8 to create a dynamically-created dictionary including the vocabulary to be recognized.

Further, when a recognition dictionary including the vocabulary to be recognized is stored in either the statically-created dictionary storage unit 5a or the dynamically-created dictionary temporary storage unit 17, the recognition dictionary dynamic creation determination unit 7b reads the recognition dictionary and stores this the recognition dictionary in the recognition dictionary storage unit 9. A voice recognition unit 10 performs voice recognition on the inputted voice by using the recognition dictionary stored in the recognition dictionary storage unit 9.

As mentioned above, because the voice recognition device according to this Embodiment 5 has the dynamically-created dictionary temporary storage unit 17 for temporarily storing a dynamically-created dictionary in addition to the structure according to above-mentioned Embodiment 4, the voice recognition device provides the same advantages as those provided by above-mentioned Embodiment 4. Further, the voice recognition device can reduce the amount of computation for the dictionary creation while suppressing the amount of storage used to a minimum.

### INDUSTRIAL APPLICABILITY

Because the voice recognition device in accordance with the present invention can reduce the usable capacity of a storage area needed for storing recognition dictionaries which the voice recognition device creates in advance while shortening the time required to create a recognition dictionary during interactive communications with the user, the voice recognition device is suitable for use as voice recognition devices used for a portable music player, a mobile phone, and a vehicle-mounted navigation system.

1. A voice recognition device which performs voice recognition while switching between vocabularies to be recognized through an interaction, said voice recognition device comprising:
a static creation unit for creating a recognition dictionary in advance for a vocabulary having words to be recognized whose number is equal to or larger than a threshold; a dynamic creation unit for creating a recognition dictionary for a vocabulary having words to be recognized whose number is smaller than said threshold in an interactive situation; and
a voice recognition unit for performing voice recognition on an inputted voice by making reference to the recognition dictionary created by said static creation unit or said dynamic creation unit.

2. The voice recognition device according to claim 1, wherein said static creation unit creates a recognition dictionary in advance for each of all vocabularies which is an object to be recognized, and said dynamic creation unit creates a recognition dictionary for a vocabulary which is selected as an object to be recognized in an interactive situation.

3. The voice recognition device according to claim 1, wherein when said static creation unit creates a recognition dictionary containing a vocabulary which is selected as an object to be recognized in an interactive situation and whose percentage of a number of words to be recognized in said recognition dictionary is equal to or larger a predetermined percentage, said dynamic creation unit does not create any recognition dictionary for said vocabulary in said interactive situation, and said voice recognition unit performs voice recognition on the inputted voice by referring to said recognition dictionary created by said static creation unit, and outputs recognition result candidates which are included in a plurality of recognition result candidates having a greater recognition likelihood and are also included in the vocabulary to be recognized this time as recognition results.

4. The voice recognition device according to claim 3, wherein said static creation unit creates a recognition dictionary for a vocabulary which is an object to be recognized in advance in such a way that the number of words to be recognized exceeds a predetermined number in the interactive situation, and the number of words to be recognized in said interactive situation is equal to or smaller than a predetermined percentage of a total number of words in the recognition dictionary.

5. The voice recognition device according to claim 1, wherein said voice recognition device includes an intermediate result storage unit for storing an intermediate result of the creation of the recognition dictionary by said static creation unit, and, when creating a recognition dictionary for a vocabulary which is commonly used for the recognition dictionary created by said static creation unit, said dynamic creation unit creates a recognition dictionary by using said intermediate result read from said intermediate result storage unit.

6. The voice recognition device according to claim 1, wherein said voice recognition device includes a temporary storage unit for temporarily storing the recognition dictionary created by said dynamic creation unit, and a storage management unit for managing whether or not to store said recognition dictionary in said temporary storage unit according to a usage status of said recognition dictionary.
